(19) United States
(12) Patent Application Publication
(10) Pub. No.: US 2018/0038297 A1
(43) Pub. Date: Feb. 8, 2018

(54) CONTROL SYSTEM FOR INTERNAL COMBUSTION ENGINE

(71) Applicant: TOYOTA JIDOSHA KABUSHIKI KAISHA, Toyota-shi (JP)

(72) Inventors: Keisuke SASAKI, Susono-shi (JP); Akira EIRAKU, Numazu-shi (JP); Masanori HATTORI, Susono-shi (JP); Yoshiyuki KAGEURA, Shizuoka-ken (JP); Teppei YOSHIOKA, Susono-shi (JP); Shinichi HIRAOKA, Susono-shi (JP)

(73) Assignee: TOYOTA JIDOSHA KABUSHIKI KAISHA, Toyota-shi (JP)

(21) Appl. No.: 15/665,699

(22) Filed: Aug. 1, 2017

(30) Foreign Application Priority Data
Aug. 3, 2016 (JP) 2016-152585

(51) Int. Cl. F02D 41/00; F02D 41/04; F02D 15/02; F02D 41/30

(52) U.S. Cl. CPC F02D 41/0085; F02D 41/3064; F02D 41/047; F02D 15/02; F02D 2041/389

(57) ABSTRACT

A control system is applied to an internal combustion engine having a plurality of cylinders, a variable compression ratio changer configured to change the compression ratio of each of the cylinders of the internal combustion engine individually, in-cylinder injection valves that inject fuel into the respective cylinders, and in-passage injection valves each of which injects fuel into an intake passage corresponding to each of the cylinders. To reduce differences in the air-fuel ratio among the cylinders during changing the compression ratio, the control system makes the proportion of the quantity of fuel injected through the in-passage injection valves to the total quantity of fuel injected through the in-cylinder injection valves and the in-passage injection valves larger during the time in which the compression ratios of all the cylinders are being changed than during the time in which the compression ratios of all the cylinders are fixed.

### CROSS REFERENCE TO RELATED APPLICATIONS

This application claims priority to Japanese Patent Application No. 2016-152585 filed on Aug. 3, 2016 the entire contents of which are incorporated by reference herein.

### TECHNICAL FIELD

The present disclosure relates to a control system for an internal combustion engine.

### BACKGROUND ART

It is known in prior art pertaining to an internal combustion engine having a variable compression ratio changer to set a target air-fuel ratio lower than the theoretical air-fuel ratio during at least a part of the period through which the compression ratio is changed from a relatively high compression ratio to a relatively low compression ratio, thereby reducing the decrease in the fuel consumption rate (see, for example, Patent Literature 1).

### CITATION LIST

### Patent Literature

Patent Literature 1: Japanese Patent Application Laid-Open No. 2004-263626

Patent Literature 2: Japanese Patent Application Laid-Open No. 2004-232580

Patent Literature 3: Japanese Patent Application Laid-Open No. 2016-118181

### SUMMARY

### Technical Problem

In the case of internal combustion engines having a system that can change the compression ratios of the cylinders individually, when the compression ratios of all the cylinders are changed at the same time, the speed of changing the compression ratio may differ among the cylinders due to variations in the response delay of the variable compression ratio changer among the cylinders. Then, there may be differences in the compression ratio among the cylinders while changing of the compression ratio is in progress. Differences in the compression ratio among the cylinders during the time in which fuel is injected by fuel injection valves that inject fuel directly into the respective cylinders may lead to differences in the intake air quantity among the cylinders. For example, in a cylinder in which the compression ratio is higher than those in the other cylinders, the distance between the fuel injection valve and the piston top is shorter than those in the other cylinders. Then, fuel injected by the fuel injection valve is more likely to adhere to the piston top in that cylinder. In consequence, the piston top is cooled by latent heat of vaporization of fuel, leading to a decrease in the temperature of the piston top. Consequently, the volumetric efficiency increases in that cylinder, and the intake air quantity increases accordingly. In consequence, if the fuel injection quantity is the same in all the cylinders, the air-fuel ratio in the cylinder having a higher compression ratio than the other cylinders becomes leaner than the air-fuel ratio in the other cylinders. Moreover, in the cylinder having a compression ratio higher than the other cylinders, the quantity of fuel contained in the air-fuel mixture decreases due to an increase in the quantity of fuel adhering to the piston top. This also leads to a leaner air-fuel ratio in that cylinder. On the other hand, in a cylinder having a lower compression ratio than the other cylinders, the air fuel ratio becomes richer than the air fuel ratio in the other cylinders, conversely to the cylinder having a higher compression ratio.

As above, if differences in the compression ratio among the cylinders arise during changing the compression ratio, differences in the air-fuel ratio among the cylinder will result. This can lead to an increase in the magnitude of rotational fluctuation or an increase in harmful emissions.

The present disclosure has been made in view of the above-described circumstances, and an object of the present disclosure is to reduce differences in the air-fuel ratio among the cylinders during changing the compression ratio.

### Solution to Problem

To solve the above problem, there is provided a control system for an internal combustion engine that controls an internal combustion engine having a plurality of cylinders, a variable compression ratio changer configured to change the compression ratio of each of the cylinders of the internal combustion engine individually, in-cylinder injection valves that inject fuel into the respective cylinders, and in-passage injection valves each of which injects fuel into an intake passage corresponding to each of the cylinders. The control system comprises a controller configured to make the proportion of the quantity of fuel injected through said in-passage injection valves to the total quantity of fuel injected through said in-cylinder injection valves and said in-passage injection valves larger during the time in which the compression ratios of all the cylinders are being changed by said variable compression ratio changer than during the time in which the compression ratios of all the cylinders are fixed.

In the following, the proportion of the quantity of fuel injected through the in-passage injection valve to the total quantity of fuel injected through the in-cylinder injection valve and the in-passage injection valve will be referred to as the proportion of injection through the in-passage injection valve. Moreover, the proportion of the quantity of fuel injected through the in-cylinder injection valve to the total quantity of fuel injected through the in-cylinder injection valve and the in-passage injection valve will be referred to as the proportion of injection through the in-cylinder injection valve. In internal combustion engines having a variable compression ratio changer, differences in the compression ratio among the cylinders may arise in some cases due to response delay or other reasons during the time when the compression ratios of all the cylinders are changed at the same time. Then, there may arise differences in the quantity of fuel adhering to the piston top, resulting in differences in the air-fuel ratio among the cylinders in some cases. To avoid this, the controller is configured to make the proportion of injection through the in-passage injection valve larger during the time in which the compression ratios of all the cylinders are being changed than during the time in which the compression ratio is not being changed, namely during the time in which the compression ratios of all the cylinders are fixed. The quantity of fuel adhering to the piston top is smaller in the case where fuel is injected by the in-passage injection valve than in the case where fuel is injected by the in-cylinder injection valve. Hence, decreasing the proportion of injection through the in-cylinder injection valve by increasing the proportion of injection through the in-passage injection valve leads to a reduction of the quantity of fuel adhering to the piston top. Moreover, increasing the proportion of injection through the in-passage injection valves for all the cylinders during changing the compression ratio leads to a reduction in the effect of cooling the piston by the latent heat of vaporization of fuel in each cylinder. Thus, even if there are differences in the compression ratio among the cylinders, differences in the volumetric efficiency among the cylinders can be reduced, and hence differences in the intake air quantity among the cylinders can be reduced. Thus, differences in the air-fuel ratio among the cylinders can be reduced. In this specification, the term “compression ratio” shall mean the mechanical compression ratio, unless otherwise stated.

The aforementioned controller may be configured to cause fuel to be injected only through said in-passage injection valves during the time in which the compression ratios of all the cylinders are being changed by said variable compression ratio changer.

By suspending the fuel injection through the in-cylinder injection valves and injecting fuel only through the in-passage injection valves, the quantity of fuel adhering to the piston top can further be reduced. In consequence, the effect of cooling the piston by the latent heat of vaporization of fuel can be reduced more reliably. Hence, differences in the air-fuel ratio among the cylinders can be reduced more reliably. During the time in which the compression ratio is fixed, fuel may be injected through either both the in-passage injection valve and the in-cylinder injection valve or only the in-cylinder injection valve.

To solve the above problem, in a control system for an internal combustion engine that controls an internal combustion engine having a plurality of cylinders, a variable compression ratio changer configured to change the compression ratio of each of the cylinders of the internal combustion engine individually, in-cylinder injection valves that inject fuel into the respective cylinders, and in-passage injection valves each of which injects fuel into an intake passage corresponding to each of the cylinders, there may be provided a controller configured to make the proportion of the quantity of fuel injected through said in-passage injection valve to the total quantity of fuel injected through said in-cylinder injection valve and said in-passage injection valve larger in a cylinder in which the air-fuel ratio is high than in a cylinder in which the air-fuel ratio is low, during the time in which the compression ratios of all the cylinders are being changed by said variable compression ratio changer.

In the case where fuel is injected by the in-cylinder injection valve during changing the compression ratio, fuel is more likely to adhere to the piston top in a cylinder in which the compression ratio is high than in a cylinder in which the compression ratio is low. Hence, if the same proportion of injection through the in-cylinder injection valve and the in-passage injection valve is set in the cylinder in which the compression ratio is high and the cylinder in which the compression ratio is low, a larger quantity of fuel will adhere to the piston head in the cylinder in which the compression ratio is high than in the cylinder in which the compression ratio is low. Thus, differences in the quantity of fuel adhering to the piston top will arise among the cylinders, leading to differences in the intake air quantity among the cylinders. In that case, it may be considered that the compression ratio in the cylinder in which the air-fuel ratio is high is higher than the compression ratio in the cylinder in which the air-fuel ratio is low. By making the proportion of injection through the in-passage injection valve larger in the cylinder in which the air-fuel ratio is high than in the cylinder in which the air-fuel ratio is low, the proportion of injection through the in-cylinder injection valve is decreased in the cylinder in which the air-fuel ratio is high, leading to a decrease in the quantity of fuel adhering to the piston. By decreasing the quantity of fuel adhering to the piston in the cylinder in which the air-fuel ratio is high, the intake air quantity can be reduced in the cylinder in which the air-fuel ratio is high. Thus, the air-fuel ratio in the cylinder in which the air-fuel ratio is high can be reduced. Consequently, differences in the air-fuel ratio among the cylinders can be decreased. Moreover, the amount of decrease in the proportion of injection through the in-cylinder injection valve may be a minimum amount necessary to compensate for the difference in the air-fuel ratio. Therefore, it is possible to prevent deterioration in advantages of fuel injection through the in-cylinder injection valve, such as improvement in the fuel economy, reduction of harmful emissions, and reduction of knock.

### Advantageous Effects

The present disclosure can reduce differences in the air-fuel ratio among the cylinders during changing the compression ratio.

### BRIEF DESCRIPTION OF DRAWINGS

FIG. 1 is a diagram showing the general configuration of an internal combustion engine according to an embodiment and its air intake and exhaust systems.

FIG. 2 is a schematic cross sectional view of the internal combustion engine according the embodiment.

FIG. 3 is a diagram showing the structure of a variable length connecting rod according to the embodiment.

FIG. 4 is a diagram showing a switching system according to the embodiment in a first state.

FIG. 5 is a diagram showing a switching system according to the embodiment in a second state.

FIG. 6 is a time chart showing the changes with time of the compression ratios of cylinders and the air-fuel ratios in the cylinders in a case where the proportion of injection through the in-cylinder injection valve is set to 100% during changing the compression ratio.

FIG. 7 is a time chart showing the changes with time of the compression ratios of the cylinders, the air-fuel ratios in the cylinders in a case where the proportion of injection through the in-cylinder injection valve is set to 100% during changing the compression ratio, and the air-fuel ratios in the cylinders in a case where the proportion of injection through the in-passage injection valve is set to 100% during changing the compression ratio.

FIG. 8 is a flow chart of a process of controlling the proportion of injection through the in-cylinder injection valve and the in-passage injection valve according to a first embodiment.

FIG. 9 is a graph showing relationship between the crank angle and the in-cylinder pressure.

FIG. 10 is a graph showing relationship between an ignition delay correlative value and the air-fuel ratio.

FIG. 11 is a block diagram illustrating the general outline of feedback control of the proportion of injection according to a second embodiment.

FIG. 12 is a time chart showing the change with time of the compression ratios, the air-fuel ratios in the cylinders, and the differences between the ignition delay correlative values of the cylinders and a target ignition delay correlative value in a case where fuel injection is performed only by the in-cylinder injection valves during changing the compression ratio.

FIG. 13 is a flow chart of a process of controlling the proportion of injection according to the second embodiment.

### DESCRIPTION OF EMBODIMENTS

In the following, modes for carrying out the present disclosure will be specifically described as embodiments for illustrative purposes with reference to the drawings. The dimensions, materials, shapes, relative arrangements, and other features of the components that will be described in connection with the embodiments are not intended to limit the technical scope of the present disclosure only to them, unless stated otherwise.

### Embodiment 1

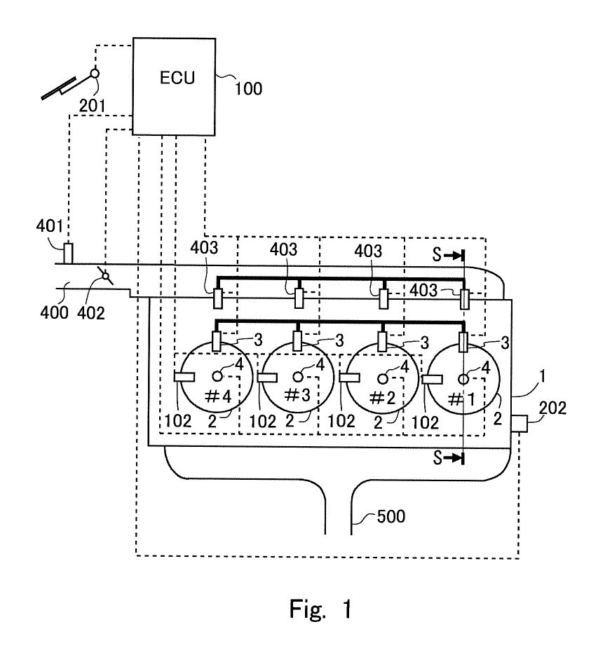

In the following, an embodiment of the present disclosure will be described with reference to the drawings. FIG. 1 is a diagram showing the general configuration of an internal combustion engine according to an embodiment and its air-intake and exhaust systems. The internal combustion engine 1 shown in FIG. 1 is a spark-ignition internal combustion engine (gasoline engine) having four cylinders 2. Each cylinder 2 of the internal combustion engine 1 is provided with an in-cylinder injection valve 3 that injects fuel directly into the cylinder 2 and an ignition plug 4 used to ignite the air-fuel mixture. Each cylinder 2 of the internal combustion engine 1 is provided with an in-cylinder pressure sensor 102 that measures the pressure in the cylinder 2. The in-cylinder pressure sensor 102 is optional in this embodiment. In one operation cycle (crank rotation angle of 720°) of the internal combustion engine 1, the firing order of the cylinders 2 is #1-#3-#4-#2 cylinders.

The internal combustion engine 1 is connected with an intake passage 400 and an exhaust passage 500. The intake passage 400 is provided with an air flow meter 401 and a throttle 402. The air flow meter 401 outputs an electrical signal representing the quantity (or mass) of the intake air flowing in the intake passage 400. The throttle 402 is arranged in the intake passage 400 downstream of the air flow meter 401. The throttle 402 varies the channel cross sectional area of the intake passage 400 to regulate the intake air quantity of the internal combustion engine 1. The exhaust passage 500 is open to the atmosphere through a catalyst and a silencer, which are not shown in the drawings.

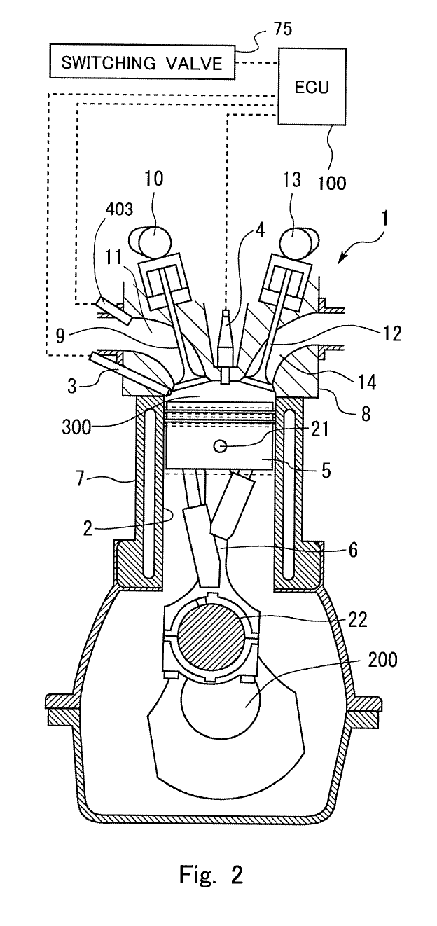

FIG. 2 is a schematic cross sectional view of the internal combustion engine 1. FIG. 2 is a schematic cross sectional view of the internal combustion engine 1 taken along line S-S in FIG. 1. As shown in FIG. 2, the internal combustion engine 1 has a cylinder block 7 and a cylinder head 8. In the cylinder block 7, a crankshaft 200 is housed in a rotatable manner. The cylindrical cylinders 2 are formed in the cylinder block 7. Pistons 5 are slidably received in the cylinders 2. The piston 5 and the crankshaft 200 are connected by a variable length connecting rod 6, which will be described later. The cylinder head 8 has an intake port 11 and an exhaust port 14 formed therein. The cylinder head 8 is provided with an intake valve 9 that closes and opens the end of the intake port 11 that opens to the combustion chamber 300 and an intake cam shaft 10 used to drive the intake valve 9 to open and close it. The cylinder head 8 is provided with an exhaust valve 12 that closes and opens the end of the exhaust port 14 that opens to the combustion chamber 300 and an exhaust cam shaft 13 used to drive the exhaust valve to open and close it. The intake passage 400 is provided with in-passage injection valves 403 each of which injects fuel to the intake port 11 or the intake passage 400 corresponding to each cylinder 2. In this embodiment, the intake port 11 or the intake passage 400 corresponding to each cylinder 2 constitutes the intake passage according to the present disclosure.

The variable length connecting rod 6 is connected to the piston 5 at its small end by a piston pin 21 and connected to a crankpin 22 of the crankshaft 200 at its big end. The variable length connecting rod 6 can vary its effective length, that is, the distance from the axis of the piston pin 21 to the axis of the crankpin 22.

When the effective length of the variable length connecting rod 6 is long, the length from the axis of the crankpin 22 to the axis of the piston pin 21 is long, and the volume of the combustion chamber 300 at the time when the piston 5 is located at the top dead center is small accordingly, as illustrated by solid lines in FIG. 2. On the other hand, when the effective length of the variable length connecting rod 6 is short, the length from the axis of the crankpin 22 to the axis of the piston pin 21 is short, and the volume of the combustion chamber 300 at the time when the piston 5 is at the top dead center is large accordingly, as illustrated by broken lines in FIG. 2. While the effective length of the variable length connecting rod 6 varies as described above, the stroke of the piston 5 does not vary. Hence, the compression ratio or the ratio of the inner volume of the cylinder (i.e. the volume of the combustion chamber) at the time when the piston 5 is at the top dead center and the inner volume of the cylinder at the time when the piston 5 is at the bottom dead center varies.

### (Structure of Variable Length Connecting Rod 6)

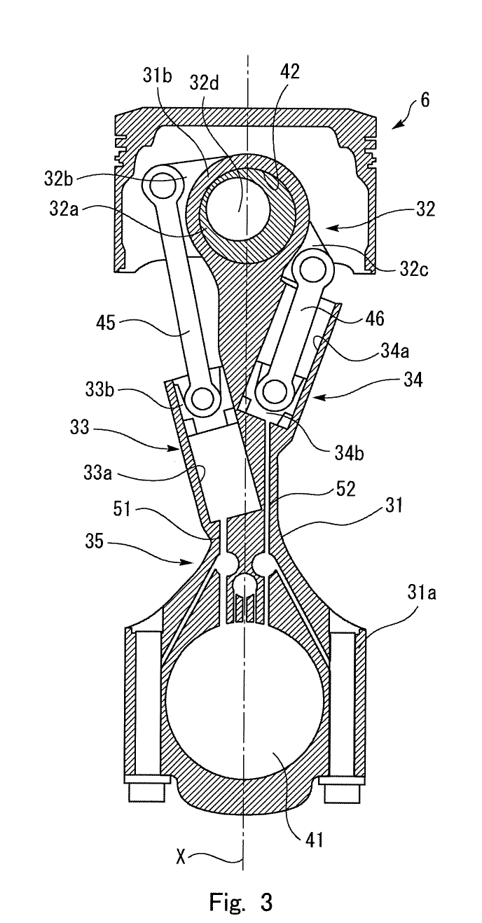

Now, the structure of the variable length connecting rod 6 in this embodiment will be described with reference to FIG. 3. The variable length connecting rod 6 includes a connecting rod main body 31, an eccentric member 32 rotatably attached to the connecting rod main body 31, a first piston mechanism 33 provided in the connecting rod main body 31, a second piston mechanism 34 provided in the connecting rod main body 31, and a switching system 35 that switches the flow of hydraulic oil to the two piston mechanisms 33, 34.

The connecting rod main body 31 has a crank receiving bore 41 at one end, which receives the crankpin 22 of the crankshaft 200, and a sleeve receiving bore 42 at the other end, which receives a sleeve of the eccentric member 32, which will be described later. Since the crank receiving bore 41 is bigger than the sleeve receiving bore 42, the end of the connecting rod main body 31 that has the crank receiving bore 41 will be called the big end 31a, and the end of the connecting rod main body 31 that has the sleeve receiving bore 42 will be called the small end 31b.

In this specification, a virtual straight line passing through the center axis of the crank receiving bore (namely, the center axis of the crankpin 22 received in the crank receiving bore 41) and the center axis of the sleeve receiving bore 42 (namely, the center axis of the sleeve received in the sleeve receiving bore 42) will be referred to as the axis X of the variable length connecting rod 6. The dimension of the variable length connecting rod 6 along the direction perpendicular to the axis X of the variable length connecting rod 6 and to the center axis of the crank receiving bore 41 will be called the width of the variable length connecting rod 6. The dimension of the variable length connecting rod 6 along the direction parallel to the center axis of the crank receiving bore 41 will be called the thickness of the variable length connecting rod 6.

The eccentric member 32 has a cylindrical sleeve 32a received in the sleeve receiving bore 42 of the connecting rod main body 31, a first arm 32b extending from the sleeve 32a in a first direction with respect to the width direction of the connecting rod main body 31, and a second arm 32c extending from the sleeve 32a in a second direction (nearly opposite to the aforementioned first direction) with respect to the width direction of the connecting rod main body 31. The sleeve 32a is rotatable in the sleeve receiving bore 42, and the eccentric member 32 is attached to the small end 31b of the connecting rod main body 31 in such a way as to be rotatable relative to the connecting rod main body 31 in the circumferential direction of the small end 31b.

The sleeve 32a of the eccentric member 32 has a piston pin receiving bore 32d that receives the piston pin 21. The piston pin receiving bore 32d has a cylindrical shape. The center axis of the cylindrical piston pin receiving bore 32d is offset from the center axis of the sleeve 32a.

In this embodiment, since the center axis of the piston pin receiving bore 32d is offset from the center axis of the sleeve 32a as described above, the rotation of the eccentric member 32 causes the position of the piston pin receiving bore 32d in the sleeve receiving bore 42 to change. When the piston pin receiving bore 32d is located at the side of the sleeve receiving bore 42 near the big end 31a, the effective length of the variable length connecting rod 6 is short. When the piston pin receiving bore 32d is located at the side of the sleeve receiving bore 42 away from the big end 31a, the effective length of the variable length connecting rod 6 is long. Thus, the effective length of the connecting rod can be changed by rotating the eccentric member 32.

The first piston mechanism 33 includes a first cylinder 33a formed in the connecting rod main body 31 and a first piston 33b capable of sliding in the first cylinder 33a. The most part or entirety of the first cylinder 33a is located on the first arm 32b side of the axis X of the connecting rod. The first cylinder 33a is oriented obliquely to the axis X at a certain angle so that the first cylinder 33a stretches out in the width direction of the connecting rod main body 31 as it extends toward the small end 31b of the connecting rod main body 31. The first cylinder 33a is in communication with the switching system 35 through a first piston communication oil channel 51.

The first piston 33b is connected to the first arm 32b of the eccentric member 32 by a first link member 45. The first piston 33b is rotatably connected to the first link member 45 by a pin. The first arm 32b is rotatably connected to the first link member 45 by a pin at its end opposite to the end at which it is connected to the sleeve 32a.

The second piston mechanism 34 includes a second cylinder 34a formed in the connecting rod main body 31 and a second piston 34b capable of sliding in the second cylinder 34a. The most part or entirety of the second cylinder 34a is located on the second arm 32c side of the axis X of the connecting rod. The second cylinder 34a is oriented obliquely to the axis X at a certain angle so that the second cylinder 34a stretches out in the width direction of the connecting rod main body 31 as it extends toward the small end 31b of the connecting rod main body 31. The second cylinder 34a is in communication with the switching system 35 through a second piston communication oil channel 52.

The second piston 34b is connected to the second arm 32c of the eccentric member 32 by a second link member 46. The second piston 34b is rotatably connected to the second link member 46 by a pin. The second arm 32c is rotatably connected to the second link member 46 by a pin at its end opposite to the end at which it is connected to the sleeve 32a.

As will be described later, the switching system 35 is a system that enables switching between a first state in which the flow of hydraulic oil from the first cylinder 33a to the second cylinder 34a is shut off and the flow of hydraulic oil from the second cylinder 34a to the first cylinder 33a is allowed and a second state in which the flow of hydraulic oil from the first cylinder 33a to the second cylinder 34a is allowed and the flow of hydraulic oil from the second cylinder 34a to the first cylinder 33a is shut off.

When the switching system 35 is in the aforementioned first state, the hydraulic oil is supplied into the first cylinder 33a, and the hydraulic oil is discharged from the second cylinder 34a. Consequently, the first piston 33b moves up, and the first arm 32b of the eccentric member 32 connected to the first piston 33b also moves up accordingly. On the other hand, the second piston 34b moves down, and the second arm 32c connected to the second piston 34b also moves down accordingly. In consequence, the eccentric member 32 turns in the clockwise direction in FIG. 3, so that the position of the piston pin receiving bore 32d shifts away from the position of the crankpin 22. In other words, the effective length of the variable length connecting rod 6 becomes longer. As the second piston 34b abuts the bottom of the second cylinder 34a, the turn of the eccentric member 32 is restricted, and the rotational position of the eccentric member 32 is maintained at that position.

When the switching system 35 is in the first state, the first piston 33b and the second piston 34b move to the aforementioned positions basically without external supply of hydraulic oil. This is because when an upward inertial force acts on the piston 5 during the reciprocation of the piston 5 in the cylinder 2 of the internal combustion engine 1, the second piston 34b is pushed in, whereby the hydraulic oil in the second cylinder 34a is transferred to the first cylinder 33a. When a downward inertial force acts on the piston 5 during the reciprocation of the piston 5 in the cylinder 2 of the internal combustion engine 1 or when a downward force acts on the piston 5 by combustion of air-fuel mixture in the combustion chamber 300, a force acts on the first piston 33b in the pushing-in direction. However, since the flow of the hydraulic oil from the first cylinder 33a to the second cylinder 34a is shut off by the switching system 35, the hydraulic oil in the first cylinder 33a does not flow out of it. Hence, the first piston 33b is not pushed in.

When the switching system 35 is in the second state, the hydraulic oil is supplied into the second cylinder 34a and discharged from the first cylinder 33a. Consequently, the second piston 34b moves up, and the second arm 32c of the eccentric member 32 connected to the second piston 34b also moves up accordingly. On the other hand, the first piston 33b moves down, and the first arm 32b connected to the first piston 33b also moves down. In consequence, the eccentric member 32 turns in the anticlockwise direction in FIG. 3, so that the position of the piston pin receiving bore 32d shifts toward the position of the crankpin 22. In other words, the effective length of the variable length connecting rod 6 becomes shorter. As the first piston 33b abuts the bottom of the first cylinder 33a, the turn of the eccentric member 32 is restricted, and the rotational position of the eccentric member 32 is maintained at that position. Thus the compression ratio of the internal combustion engine 1 is lower when the switching system 35 is in the aforementioned second state than when it is in the aforementioned first state. In the following, the compression ratio in the state in which the switching system 35 is in the aforementioned first state will be referred to as the “first compression ratio”, and the compression ratio in the state in which the switching system 35 is in the aforementioned second state will be referred to as the “second compression ratio”. The first compression ratio is higher than the second compression ratio.

When the switching system 35 is in the second state, the first piston 33b and the second piston 34b move to the aforementioned positions basically without external supply of hydraulic oil. This is because when a downward inertial force acts on the piston 5 during the reciprocation of the piston 5 in the cylinder 2 of the internal combustion engine 1 or when a downward force acts on the piston 5 by combustion of air-fuel mixture in the combustion chamber 300, the first piston 33b is pushed in, whereby the hydraulic oil in the first cylinder 33a is transferred to the second cylinder 34a. When an upward inertial force acts on the piston 5 during the reciprocation of the piston 5 in the cylinder 2 of the internal combustion engine 1, a force acts on the second piston 34b in the pushing-in direction. However, since the flow of the hydraulic oil from the second cylinder 34a to the first cylinder 33a is shut off by the switching system 35, the hydraulic oil in the second cylinder 34a does not flow out of it. Hence, the second piston 34b is not pushed in.

### (Structure of the Switching System 35)

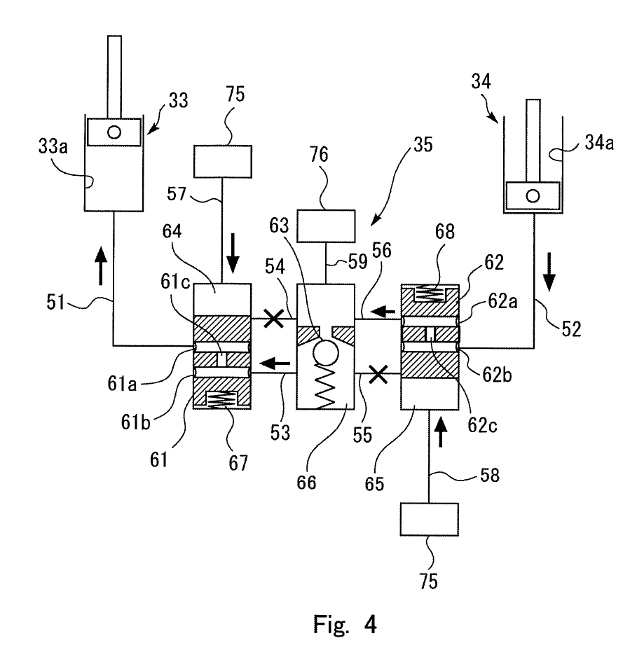

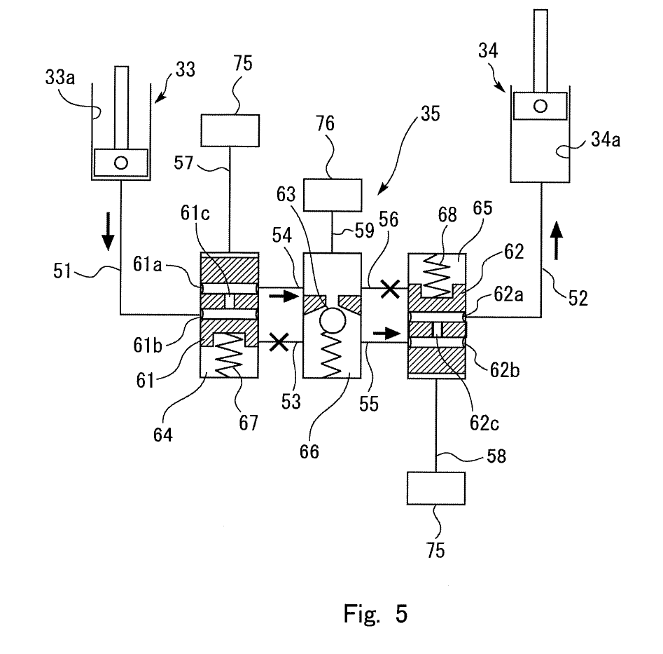

An embodiment of the switching system will be described with reference to FIGS. 4 and 5. FIG. 4 shows the switching system 35 in the first state, and FIG. 5 shows the switching system 35 in the second state. The arrows in FIGS. 4 and 5 indicate flows of the hydraulic oil in those states. The switching system 35 includes two switching pins 61, 62 and a check valve 63. The two switching pins 61 and 62 are slidably housed in cylindrical pin housing spaces 64 and 65 respectively.

A first switching pin 61 among the aforementioned two switching pins 61, 62 has two circumferential grooves 61a, 61b extending along its circumference. The circumferential grooves 61a, 61b are in communication with each other through a communication channel 61c formed in the first switching pin 61. In the first pin housing space 64, in which the first switching pin 61 is housed, a first bias spring 67 that biases the first switching pin 61 is provided.

The second switching pin 62 among the aforementioned two switching pins 61, 62 also has two circumferential grooves 62a, 62b extending along its circumference. The circumferential grooves 62a, 62b are in communication with each other through a communication channel 62c formed in the second switching pin 62. In the second pin housing space 65, in which the second switching pin 62 is housed, a second bias spring 68 that biases the second switching pin 62 is also provided.

The check valve 63 is housed in a check valve housing space 66 having a cylindrical shape. The check valve 63 is adapted to allow the fluid flow from the primary or upstream side (i.e. the upper side in FIG. 4) to the secondary or downstream side (i.e. the lower side in FIG. 4) and to interrupt the fluid flow from the secondary side to the primary side.

The first pin housing space 64 in which the first pin 61 is housed is in communication with the first cylinder 33a through the first piston communication oil channel 51. The first pin housing space 64 is in communication with the check valve housing space 66 through two space communication oil channels 53, 54. One of the two space communication oil channels, or the first space communication oil channel 53, provides communication between the first pin housing space 64 and the secondary side of the check valve housing space 66. The other of the two space communication oil channels, or the second space communication oil channel 54, provides communication between the first pin housing space 64 and the primary side of the check valve housing space 66.

The second pin housing space 65 in which the second switching pin 62 is housed is in communication with the second cylinder 34a through the second piston communication oil channel 52. The second pin housing space 65 is in communication with the check valve housing space 66 through two space communication oil channels 55, 56. One of the two space communication oil channels, or the third space communication oil channel 55, provides communication between the second pin housing space 65 and the secondary side of the check valve housing space 66. The other of the two space communication oil channels, or the fourth space communication oil channel 56, provides communication between the second pin housing space 65 and the primary side of the check valve housing space 66.

The first pin housing space 64 is in communication with a first control oil channel 57 formed in the connecting rod main body 31. Specifically, the first control oil channel 57 is in communication with the first pin housing space 64 at its end opposite to the end at which the first bias spring 67 is provided. The second pin housing space 65 is in communication with a second control oil channel 58 formed in the connecting rod main body 31. Specifically, the second control oil channel 58 is in communication with the second pin housing space 65 at its end opposite to the end at which the second bias spring 68 is provided. The first control oil channel 57 and the second control oil channel 58 are in communication with the crank receiving bore 41 and with an external switching valve 75 through an oil channel (not shown) formed in the crankpin 22. The switching valve 75 is, for example, a valve system that enables switching between communication and interruption between the two control oil channels 57, 58 and an oil pump that is not shown in the drawings.

The primary side of the check valve housing space 66 is in communication with a hydraulic oil source 76 such as an oil pump through an additional oil channel 59. The additional oil channel 59 is an oil channel though which oil is added to compensate for oil leaking from some portions of the switching system 35 to the outside.

### (Operation of the Switching System 35)

In the above-described switching system 35, when the switching valve 75 allows the communication between the control oil channels 57, 58 and hydraulic oil source 76, the bias springs 67, 68 are compressed by the hydraulic pressure acting on the switching pins 61, 62 as shown in FIG. 4, so that the switching pins 61, 62 are brought to and kept at positions that allow communication between the first piston communication oil channel 51 and the first space communication oil channel 53 through the communication channel 61c of the first switching pin 61 and communication between the second piston communication oil channel 52 and the fourth space communication oil channel through the communication channel 62c of the second switching pin 62. Thus, the first cylinder 33a is connected to the secondary side of the check valve 63, and the second cylinder 34a is connected to the primary side of the check valve 63. In consequence, while the hydraulic oil in the second cylinder 34a can be transferred to the first cylinder 33a through the second piston communication oil channel 52, the fourth space communication oil channel 56, the first space communication oil channel 53, and the first piston communication oil channel 51, the hydraulic oil in the first cylinder 33a cannot be transferred to the second cylinder 34a. Hence, when the switching valve 75 keeps the control oil channels 57, 58 and the hydraulic oil source 76 in communication with each other, the state (or the first state) in which the flow of the hydraulic oil from the first cylinder 33a to the second cylinder 34a is shut off and the flow of the hydraulic oil from the second cylinder 34a to the first cylinder 33a is allowed is established.

When the switching valve 75 interrupts the communication between the control oil channels 57, 58 and the hydraulic oil source 76, the bias springs 67, 68 expand as shown in FIG. 5, so that the switching pins 61, 62 are brought to and kept at positions that allow communication between the first piston communication oil channel 51 and the second space communication oil channel 54 through the communication channel 61c of the first switching pin 61 and communication between the second piston communication oil channel 52 and the third space communication oil channel 55 through the communication channel 62c of the second switching pin 62. Thus, the first cylinder 33a is connected to the primary side of the check valve 63, and the second cylinder 34a is connected to the secondary side of the check valve 63. In consequence, while the hydraulic oil in the first cylinder 33a can be transferred to the second cylinder 34a through the first piston communication oil channel 51, the second space communication oil channel 54, the third space communication oil channel 55, and the second piston communication oil channel 52, the hydraulic oil in the second cylinder 34a cannot be transferred to the first cylinder 33a. Hence, when the switching valve 75 interrupts the communication between the control oil channels 57, 58 and the hydraulic oil source 76, the state (or the second state) in which the flow of the hydraulic oil from the first cylinder 33a to the second cylinder 34a is allowed and the flow of the hydraulic oil from the second cylinder 34a to the first cylinder 33a is shut off is established.

As described above, switching by the switching valve 75 between supply of hydraulic oil to the first pin housing space 64 and the second pin housing space 65 and its interruption enables switching between the first state and the second state of the switching system 35. Thus, the compression ratio of the internal combustion engine 1 can be selectively set to either the first compression ratio (high compression ratio) or the second compression ratio (low compression ratio).

Referring back to FIG. 1, an electronic control unit (ECU, controller) 100 is provided for the internal combustion engine 1 having the above-described configuration. The ECU 100 is a unit that controls the operation state of the internal combustion engine 1. The ECU 100 is electrically connected with various sensors including the aforementioned air flow meter 401, the aforementioned in-cylinder pressure sensor 102, an accelerator position sensor 201, and a crank position sensor 202. The accelerator position sensor 201 is a sensor that outputs an electrical signal representing the amount of operation of the accelerator pedal (the accelerator opening degree). The crank position sensor 202 is a sensor that outputs an electrical signal representing the rotational position of the engine output shaft (or crankshaft) of the internal combustion engine 1. Output signals of these sensors are input to the ECU 100. The ECU 100 calculates the engine load of the internal combustion engine 1 on the basis of the output signal of the accelerator position sensor 201. The ECU 100 also calculates the engine speed of the internal combustion engine 1 on the basis of the output signal of the crank position sensor 202.

The ECU 100 is also electrically connected with various components including the in-cylinder injection valve 3, the in-passage injection valve 403, the ignition plug 4, the throttle 402, and the switching valve 75. These components are controlled by the ECU 100. For example, the ECU 100 controls the switching valve 75 according to the engine load. Specifically, when the engine load is lower than a predetermined threshold, the ECU 100 controls the switching valve 75 in such a way as to set the compression ratio of the internal combustion engine 1 to the aforementioned first compression ratio (namely, to set the switching system 35 to the first state or the high compression ratio state). When the engine load is equal to or higher than the aforementioned predetermined threshold, the ECU 100 controls the switching valve 75 in such a way as to set the compression ratio of the internal combustion engine 1 to the second compression ratio (namely, to set the switching system 35 to the second state or the low compression ratio state). In the internal combustion engine 1 according to this embodiment, the top dead center position of the piston 5 in each of the cylinders 2 changes when the effective length of the variable length connecting rod 6 changes. The switching valve 75 is provided for the variable length connecting rod 6 of each cylinder 2, and therefore the compression ratio of each cylinder 2 can be changed individually. In this embodiment, the variable length connecting rod 6 constitutes the variable compression ratio changer according to the present disclosure.

The ECU 100 sets a target air-fuel ratio on the basis of the operation state of the internal combustion engine 1 (e.g. the engine speed and the accelerator opening degree). The ECU 100 controls the throttle 402, the in-cylinder injection valve 3, and the in-passage injection valve 403 so as to make the actual air-fuel ratio equal to the target air-fuel ratio. Moreover, the ECU 100 controls the proportion of the quantity of fuel injected through the in-cylinder injection valve 3 in the total fuel injection quantity (or the proportion of injection through the in-cylinder injection valve 3) and the proportion of the quantity of fuel injected through the in-passage injection valve 403 in the total fuel injection quantity (or the proportion of injection through the in-passage injection valve 403). The total fuel injection quantity is the sum total of the quantity of fuel injected through the in-cylinder injection valve 3 and the in-passage injection valve 403. The ECU 100 sets the fuel injection quantities through the in-cylinder injection valve 3 and the in-passage injection valve 403 during the time in which the compression ratio is being changed and during the time in which the compression ratio is fixed in such a way that the proportion of injection through the in-passage injection valve 403 is larger during the time in which the compression ratio is being changed than during the time in which the compression ratio is not being changed, namely during the time in which the compression ratio is fixed. The proportion of injection through the in-cylinder injection valve 3 and the proportion of injection through the in-passage injection valve 403 during the time in which the compression ratio is fixed are determined in advance by, for example, experiment or simulation and stored in the ECU 100.

As above, in this embodiment, the proportion of injection through the in-cylinder injection valve 3 is set smaller and the proportion of injection through the in-passage injection valve 403 is set larger during the time in which changing of the compression ratio is in progress than during the time in which the compression ratio is fixed. In this embodiment, while changing of the compression ratio is in progress, the proportion of injection through the in-passage injection valve 403 may be set to 100%, and the fuel injection through the in-cylinder injection valve 3 may be suspended. Moreover, while the compression ratio is being fixed, the proportion of injection through the in-cylinder injection valve 3 may be set to 100%, and the fuel injection through the in-passage injection valve 403 may be suspended, or fuel injection may be performed through the in-cylinder injection valve 3 and the in-passage injection valve 403 both.

When the compression ratio is changed from the second compression ratio to the first compression ratio or from the first compression ratio to the second compression ratio by the variable compression ratio changer of this embodiment in all the cylinders 2 at the same time, there may be differences in the speed of changing the compression ratio among the cylinders 2 due to differences in the response delay among the cylinders 2. If there are differences in the speed of changing the compression ratio among the cylinders 2 during changing the compression ratio, differences in the intake air quantity among the cylinders 2 may arise while the compression ratio is being changed, as will be described below. Fuel injected from the in-cylinder injection valve 3 is apt to adhere to the piston 5. More specifically, the shorter the distance from the in-cylinder injection valve 3 to the piston 5 is, the more fuel is likely to adhere to the piston 5. If there are differences in the compression ratio among the cylinders 2, there will arise differences in the distance from the in-cylinder injection valve 3 to the piston 5 among the cylinders 2. Then, there will be differences in the quantity of fuel adhering to the piston 5 among the cylinders 2, resulting in differences in the effect of cooling the piston 5 by the fuel adhering to the piston 5. In consequence, there arise differences in volumetric efficiency among the cylinders 2, leading to differences in the intake air quantity among the cylinders 2. Since there are no differences in the fuel injection quantity through the in-cylinder injection valve 3 among the cylinders 2, differences in the intake air quantity among the cylinders lead to differences in the air-fuel ratio among the cylinders 2.

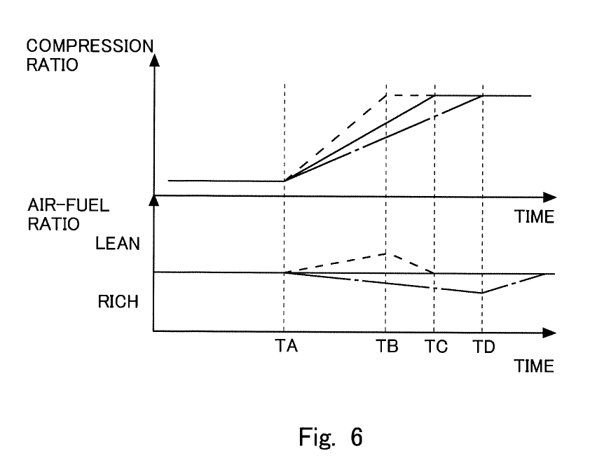

FIG. 6 is a time chart showing the changes with time of the compression ratios of the cylinders 2 and the air-fuel ratios in the cylinders 2 in a case where the proportion of injection through the in-cylinder injection valve 3 is set to 100% during changing the compression ratio. The time chart in FIG. 6 may be considered to be one with an internal combustion engine that has the in-cylinder injection valve 3 but does not have the in-passage injection valve 403. In FIG. 6, the solid line is for a cylinder of which the speed of changing the compression ratio is equal to a standard speed, the broken line is for a cylinder of which the speed of changing the compression ratio is higher than the standard speed, and the dot-and-dash line is for a cylinder of which the speed of changing the compression ratio is lower than the standard speed. The standard speed is the speed of changing the compression ratio in cylinders 2 having a standard speed of changing the compression ratio. The standard speed may be considered to be an intended speed to be achieved. FIG. 6 shows a case where the compression ratio is changed from the second compression ratio (or low compression ratio) to the first compression ratio (high compression ratio). At time TA, the compression ratio starts to be increased. At time TB, the compression ratio of the cylinder of which the compression ratio changing speed is higher than the standard speed reaches the first compression ratio. At time TC, the compression ratio of the cylinder of which the compression ratio changing speed is equal to the standard speed reaches the first compression ratio. At time TD, the compression ratio of the cylinder of which the compression ratio changing speed is lower than the standard speed reaches the first compression ratio.

In the cylinder 2 of which a compression ratio changing speed is higher than the standard speed, the quantity of fuel adhering to the piston 5 is large, and hence the effect of cooling the piston 5 by fuel is high. In consequence, the intake air quantity is increased due to an increased volumetric efficiency in that cylinder 2. Thus, the air-fuel ratio in that cylinder 2 becomes leaner than that in the cylinder 2 of which the compression ratio changing speed is equal to the standard speed. Conversely, in the cylinder 2 of which the compression ratio changing speed is lower than the standard speed, the quantity of fuel adhering to the piston 5 is small, and hence the effect of cooling the piston 5 by fuel is low. In consequence, the intake air quantity is decreased due to a decreased volumetric efficiency in that cylinder 2. Thus, the air-fuel ratio in that cylinder 2 becomes richer than that in the cylinder 2 of which the compression ratio changing speed is equal to the standard speed.

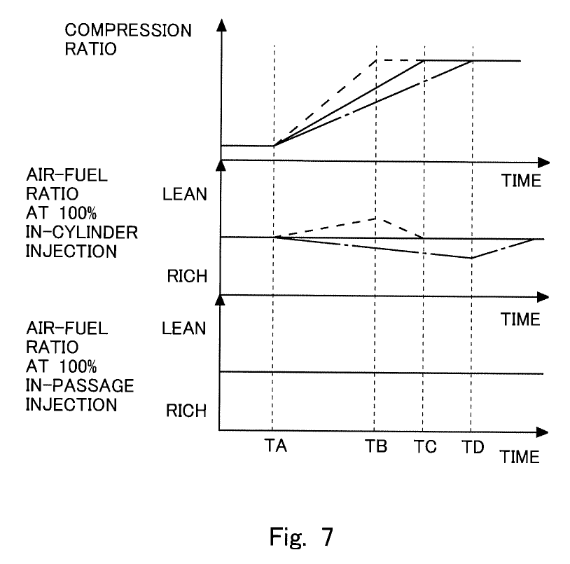

FIG. 7 is a time chart showing the changes with time of the compression ratios of the cylinders 2, the air-fuel ratios in the cylinders 2 in a case where the proportion of injection through the in-cylinder injection valve 3 is set to 100% during changing the compression ratio (the air fuel ratios at 100% in-cylinder injection), and the air-fuel ratios in the cylinders 2 in a case where the proportion of injection through the in-passage injection valve 403 is set to 100% during changing the compression ratio (the air fuel ratios at 100% in-passage injection). What is represented by the solid line, broken line, and dot-and-dash line and what is denoted by TA, TB, TC, and TD in FIG. 7 are the same as those in FIG. 6. The air-fuel ratio in the case where the proportion of injection through the in-cylinder injection valve 3 is set to 100% is the same as that shown in FIG. 6. In other words, the air-fuel ratio at 100% in-cylinder injection is the air-fuel ratio in the case where fuel injection is performed only through the in-cylinder injection valve 3. The air-fuel ratio at 100% in-passage injection is the air-fuel ratio in the case where the proportion of injection through the in-cylinder injection valve 3 is set to 100% while the compression ratio is fixed and in the case where the proportion of injection through the in-passage injection valve 403 is set to 100% while the compression ratio is being changed. As fuel is injected only through the in-passage injection valve 403, fuel scarcely adheres to the top of the piston 5, preventing differences in the volumetric efficiency among the cylinders 2 from arising. Thus, differences in the air-fuel ratio among the cylinders 2 can be prevented from arising.

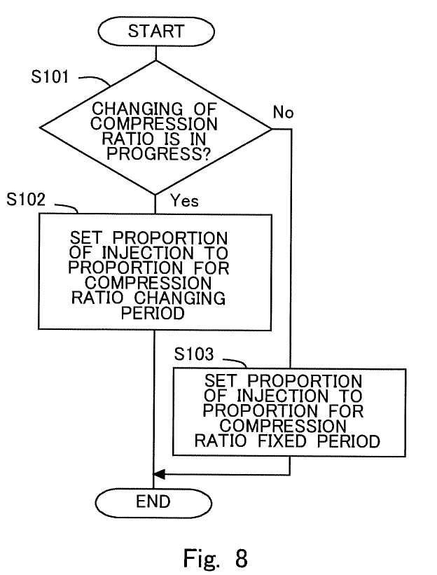

FIG. 8 is a flow chart of the process of controlling the proportion of injection through the in-cylinder injection valve 3 and the in-passage injection valve 403 according to this embodiment. The process according to this flow chart is executed by the ECU 100 at predetermined intervals.

In step S101, the ECU 100 determines whether or not changing of the compression ratio is in progress. Specifically, for example, the maximum time needed to change the compression ratios of all the cylinders 2 even with differences in the compression ratio changing speed among the cylinders 2 is determined in advance by, for example, experiment or simulation, and if the time elapsed since the time of start of changing the compression ratio is shorter than this maximum time needed to change the compression ratio, the ECU 100 determines that the changing of the compression ratio is in progress (i.e. has not been finished). Thus, even in cases where the changing of the compression ratio has finished actually, it is considered that changing of the compression ratio is in progress so long as the time assumed to be needed to change the compression ratio has not elapsed. If the determination made in step S101 is affirmative, the process proceeds to step S102. If the determination made in step S101 is negative, the process proceeds to step S103.

In step S102, the ECU 100 sets the proportion of injection through the in-cylinder injection valve 3 and the in-passage injection valve 403 to a proportion of injection for the compression ratio changing period (i.e. the period during which changing of the compression ratio is in progress). In step S103, the ECU 100 sets the proportion of injection through the in-cylinder injection valve 3 and the in-passage injection valve 403 to a proportion of injection for the compression ratio fixed period (i.e. the period during which the compression ratio is fixed). In steps S102 and S103, the proportion of injection is set in such a way that the proportion of injection through the in-passage injection valve 403 set in step S102 is larger than the proportion of injection through the in-passage injection valve 403 set in step S103, if the conditions other than the compression ratio is the same. The proportion of injection set in step S102 may be calculated by multiplying the proportion of injection set in step S103 by a correction factor or determined in advance by, for example, experiment or simulation. The proportion of injection through the in-passage injection valve 403 set in step S102 is larger than the proportion of injection through the in-passage injection valve 403 that is set during the time in which the compression ratio is fixed at the first compression ratio and the proportion of injection through the in-passage injection valve 403 that is set during the time in which the compression ratio is fixed at the second compression ratio. In this embodiment, the proportion of injection through the in-passage injection valve 403 may be set to 100% in step S102, and the proportion of injection through the in-cylinder injection valve 3 may be set to 100% in step S103. After the completion of the processing of step S102 or S103, the process according to the flow chart of FIG. 8 is terminated.

As described above, in this embodiment, the proportion of the quantity of fuel injected through the in-passage injection valve 403 to the total quantity of fuel injected through the in-cylinder injection valve 3 and the in-passage injection valve 403 is set larger during the time in which changing of the compression ratio of the internal combustion engine 1 is in progress than during the time in which the compression ratio is fixed. This can prevent or reduce differences in the air-fuel ratio among the cylinders 2 during changing the compression ratio. While the variable compression ratio changer having the structure shown in FIGS. 2 to 5 has been described in this embodiment, the present disclosure can be applied also to variable compression ratio changers having other structures that can change the compression ratio of the cylinders individually.

### Embodiment 2

In the second embodiment, the ECU 100 adjusts the proportion of injection through the in-cylinder injection valve 3 and the in-passage injection valve 403 in each cylinder 2 according to the air-fuel ratio in each cylinder during changing the compression ratio of the internal combustion engine 1. In this adjustment, the proportion of injection through the in-passage injection valve 403 in the cylinder in which the air-fuel ratio is higher is set larger than that in the cylinder in which the air-fuel ratio is lower. Other features including the structure of the system are the same as those in the first embodiment and will not be described further.

If the proportion of injection through the in-passage injection valve 403 is increased during changing the compression ratio uniformly in all the cylinders as in the first embodiment, there is a possibility that the proportion of injection through the in-passage injection valve 403 may increase excessively. To improve fuel economy, reduce harmful emissions, and prevent knocking, it is preferable to increase the proportion of injection through the in-cylinder injection valve 3. During the time in which the compression ratio is being changed also, it is preferable that the proportion of injection through the in-passage injection valve 403 be set to the minimum necessary proportion. For this reason, in this embodiment, the proportion of injection through the in-cylinder injection valve 3 and the in-passage injection valve 403 in each cylinder 2 during changing the compression ratio is adjusted according to the air-fuel ratio in each cylinder, thereby making the proportion of injection through the in-passage injection valve minimum.

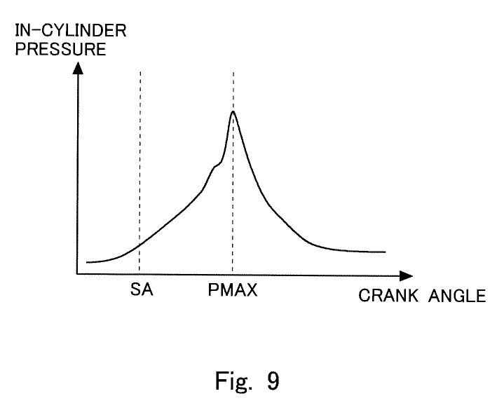

Since it is difficult to directly measure the air-fuel ratio in each cylinder 2, the proportion of injection through the in-passage injection valve 403 is adjusted on the basis of a physical quantity correlating with the ignition delay in each cylinder 2 in this embodiment. Since the ignition delay correlates with the air-fuel ratio, a physical quantity that correlates with the ignition delay also correlates with the air-fuel ratio. The ECU 100 calculates the physical quantity correlating with the ignition delay in each cylinder 2 on the basis of the measurement value of the in-cylinder pressure sensor 102. FIG. 9 is a graph showing relationship between the crank angle and the in-cylinder pressure. In FIG. 9, SA is the time of ignition by the ignition plug 4, and PMAX is the time at which the in-cylinder pressure becomes highest. In this embodiment, the crank angle from the time of ignition SA by the ignition plug 4 to the time PMAX at which the in-cylinder pressure becomes highest is calculated as the physical quantity correlating with the ignition delay. In this embodiment, the crank angle from the time of ignition by the ignition plug 4 to the time at which the in-cylinder pressure becomes highest will be referred to as the ignition delay correlative value DI. The ECU 100 calculates the ignition delay correlative value DI by the following equation.

DI=PMAX−SA

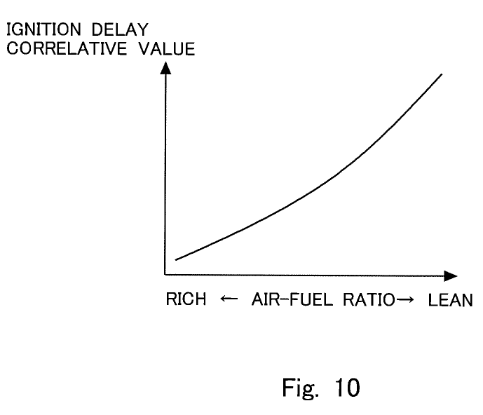

The larger the actual ignition delay is, the larger the ignition delay correlative value DI is. In the following, the ignition delay correlative value of the #i cylinder will be denoted by DI(#i), where i is one of the numbers from 1 to 4, and the #i cylinder is one of the #1 to #4 cylinders 2. The time of ignition SA by the ignition plug 4 is set by the ECU 100 according to, for example, the engine speed and the engine load, and hence the value of the time of ignition SA is known. The time PMAX at which the in-cylinder pressure becomes maximum is determined by measuring the crank angle at which the measurement value of the in-cylinder pressure sensor 102 becomes highest by the crank position sensor 202. The ignition delay correlative value thus calculated relates to the air-fuel ratio as follows. FIG. 10 is a graph showing relationship between the ignition delay correlative value and the air-fuel ratio. As shown in FIG. 10, there is a correlation between the ignition delay correlative value and the air-fuel ratio, where the leaner the air-fuel ratio is, the larger the ignition delay correlative value is.

In this embodiment, the ECU 100 calculates the ignition delay correlative value DI(#i) of each cylinder 2 and a target ignition delay correlative value DI_TR, which is a target value of the ignition delay correlative value DI(#i) for all the cylinders 2, and corrects the proportion of injection through the in-passage injection valve 403 taking account of the difference between the ignition delay correlative value DI(#i) of each cylinder 2 and the target ignition delay correlative value DI_TR. More specifically, the ECU 100 corrects the proportion of injection by feedback control (e.g. proportional integral (PI) control) so as to eliminate the difference between the ignition delay correlative value DI(#i) of each cylinder 2 and the target ignition delay correlative value DI_TR (or make the difference equal to zero).

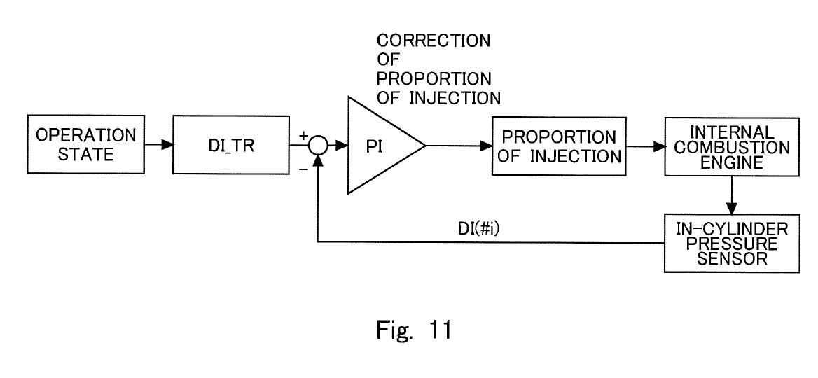

FIG. 11 is a block diagram illustrating the general outline of the feedback control of the proportion of injection in this embodiment. The proportion of injection through the in-passage injection valve 403 is corrected by this feedback control on a cylinder-by-cylinder basis. In this feedback control, as shown in FIG. 11, the target ignition delay correlative value DI_TR is set according to the operation state of the internal combustion engine 1 (specifically, engine speed and the engine load). The ignition delay correlative value DI(#i) is a value calculated as the crank angle from the time of ignition to the time at which the in-cylinder pressure becomes highest. The ignition delay correlative value DI(#i) is calculated for each cylinder 2 in every cycle.

In this feedback control, PI control is used for example to adjust the proportion of injection through the in-passage injection valve 403 so as to eliminate the difference between the target ignition delay correlative value DI_TR and the ignition delay correlative value DI(#i) of each cylinder 2. In this PI control, the proportion of injection through the in-passage injection valve 403 in the target cylinder 2 (i.e. the cylinder 2 for which the PI control is applied) is corrected using the difference between the ignition delay correlative value DI(#i) and the target ignition delay correlative value DI_TR and a predetermined PI gains (proportional and integral gains). In this way, the proportion of injection through the in-passage injection valve 403 is adjusted by feedback control. The proportion of injection through the in-cylinder injection valve 3 can be determined by subtracting the proportion of injection through the in-passage injection valve 403 from 100%. If the proportion of injection through the in-cylinder injection valve 3 is determined, the proportion of injection through the in-passage injection valve 403 is also determined. Therefore, the proportion of injection through the in-cylinder injection valve 3 may be corrected instead of correcting the proportion of injection through the in-passage injection valve 403 by feedback control.

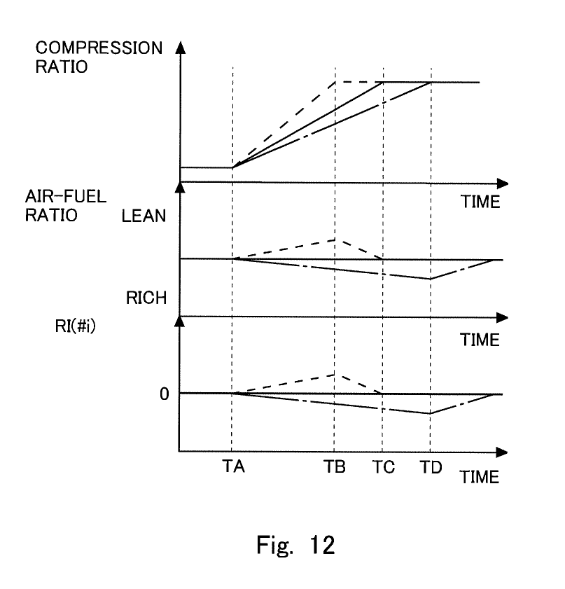

FIG. 12 is a time chart showing the changes with time of the compression ratios of the cylinders 2, the air-fuel ratios of the cylinders 2, and the differences RI(#i) between the ignition delay correlative values DI(#i) of the cylinders 2 and the target ignition delay correlative value DI_TR (where RI(#i)=DI(#i)−DI_TR) in the case where the proportion of injection through the in-cylinder injection valve 3 is set to 100% during changing the compression ratio. What is represented by the solid line, broken line, and dot-and-dash line and what is denoted by TA, TB, TC, and TD in FIG. 12 are the same as those in FIG. 6. FIG. 12 may be considered to be a time chart with an internal combustion engine that has the in-cylinder injection valve 3 but does not have the in-passage injection valve 403. In the cylinder in which the compression ratio changing speed is equal to the standard speed, the ignition delay correlative value DI(#i) is equal to the target ignition delay correlative value DI_TR, and the air-fuel ratio is equal to the target air-fuel ratio.

In the cylinder 2 in which the compression ratio changing speed is higher than the standard speed, the quantity of fuel adhering to the piston 5 is large, and hence the effect of cooling the piston 5 by fuel is high. In consequence, the intake air quantity is larger due to larger volumetric efficiency and hence the air-fuel ratio is leaner in that cylinder 2 than in the cylinder 2 in which the compression ratio changing speed is equal to the standard speed. In other words, the air-fuel ratio in the cylinder 2 in which the compression ratio changing speed is higher than the standard speed is higher than the target air-fuel ratio. Consequently, the ignition delay correlative value DI(#i) becomes larger, making the difference RI(#i) between the ignition delay correlative value DI(#i) and the target ignition delay correlative value DI_TR larger than 0. Then, the feedback control of the proportion of injection adjusts the proportion of injection through the in-passage injection valve 403 in such a way as to make the ignition delay correlative value DI(#i) smaller, namely to make the air-fuel ratio richer. Since the total fuel injection quantity is not changed when changing the proportion of injection through the in-passage injection valve 403, the air-fuel ratio may be made richer by decreasing the intake air quantity. To decrease the intake air quantity, the quantity of fuel adhering to the piston 5 may be decreased to reduce the effect of cooling the piston 5, thereby reducing the volumetric efficiency. Specifically, the proportion of injection through the in-cylinder injection valve 3 may be decreased and the proportion of injection through the in-passage injection valve 403 may be increased so as to decrease the quantity of fuel adhering to the piston 5.

Conversely to the above, in the cylinder 2 in which the compression ratio changing speed is lower than the standard speed, the quantity of fuel adhering to the piston 5 is small, and hence the effect of cooling the piston 5 by fuel is low. In consequence, the intake air quantity is smaller due to smaller volumetric efficiency and hence the air-fuel ratio is richer in that cylinder 2 than in the cylinder 2 in which the compression ratio changing speed is equal to the standard speed. In other words, the air-fuel ratio in the cylinder 2 in which the compression ratio changing speed is lower than the standard speed is lower than the target air-fuel ratio. Consequently, the ignition delay correlative value DI(#i) becomes smaller, making the difference RI(#i) between the ignition delay correlative value DI(#i) and the target ignition delay correlative value DI_TR smaller than 0. Then, the feedback control of the proportion of injection adjusts the proportion of injection through the in-passage injection valve 403 in such a way as to make the ignition delay correlative value DI(#i) larger, namely to make the air-fuel ratio leaner. Since the total fuel injection quantity is not changed when changing the proportion of injection through the in-passage injection valve 403, the air-fuel ratio may be made leaner by increasing the intake air quantity. To increase the intake air quantity, the quantity of fuel adhering to the piston 5 may be increased to enhance the effect of cooling the piston 5, thereby increasing the volumetric efficiency. Specifically, the proportion of injection through the in-cylinder injection valve 3 may be increased and the proportion of injection through the in-passage injection valve 403 may be decreased so as to increase the quantity of fuel adhering to the piston 5.

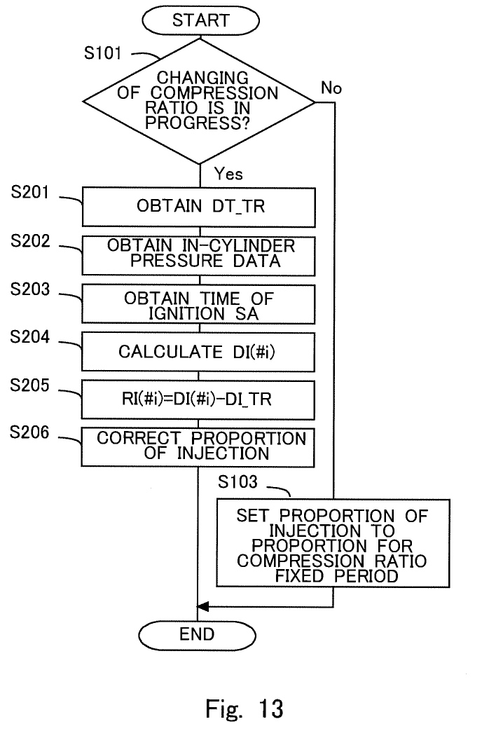

FIG. 13 is a flow chart of the process of controlling the proportion of injection in this embodiment. The process according to this flow chart is executed by the ECU 100 at least after the highest in-cylinder pressure has been reached in the target cylinder 2 (e.g. after the expansion stroke). The process according to the flow chart of FIG. 13 is executed for each cylinder 2 on a cylinder-by-cylinder basis. The steps in FIG. 13 in which the processing same as that in the flow chart in FIG. 8 is executed are denoted by the same reference signs and will not be described further. In this process, if an affirmative determination is made in step S101, the process proceeds to step S201.

In step S201, the ECU 100 obtains the target ignition delay correlative value DI_TR. The target ignition delay correlative value DI_TR is determined in advance by, for example, experiment or simulation and stored in the ECU 100 as a map. In this step S201, data is read from the map. After the completion of the processing of step S201, the process proceeds to step S202.

In step S202, the ECU 100 obtains data of the in-cylinder pressure of the target cylinder 2. In the ECU 100, measurement values of the in-cylinder pressure sensors 102 in each cylinder 2 are stored in association with crank angles. In this step S202, the stored data is read. After the completion of the processing of step S202, the process proceeds to step S203.

In step S203, the ECU 100 obtains the time of ignition SA of the target cylinder 2. The time of ignition SA of each cylinder 2 is stored in the ECU 100. In this step S203, the stored data is read. After the completion of the processing of step S203, the process proceeds to step S204.

In step S204, the ECU 100 calculates the ignition delay correlative value DI(#i) of the target cylinder 2. The ECU 100 calculates the ignition delay correlative value DI(#i) of the target cylinder 2 by subtracting the time of ignition SA read in step S203 from the time PMAX at which the in-cylinder pressure data read in step S202 becomes highest. After the completion of the processing of step S204, the process proceeds to step S205.

In step S205, the ECU 100 calculates the difference RI(#i) between the ignition delay correlative value DI(#i) and the target ignition delay correlative value DI_TR (where RI(#i)=DI(#i)−DI_TR).

In step S206, the ECU 100 corrects the proportion of injection through the in-cylinder injection valve 3 and the in-passage injection valve 403 on the basis of the difference RI(#i) between the ignition delay correlative value DI(#i) and the target ignition delay correlative value DI_TR calculated in step S205 and predetermined PI gains. The predetermined PI gains are determined in advance by, for example, experiment or simulation and stored in the ECU 100. In this step S206, the proportion of injection is corrected in such a way as to make the difference RI(#i) between the ignition delay correlative value DI(#i) and the target ignition delay correlative value DI_TR equal to zero. After the completion of the processing of step S206, the process according to the flow chart of FIG. 13 is ended.

By the above-described control process, the larger the difference RI(#i) between the ignition delay correlative value DI(#i) and the target ignition delay correlative value DI_TR is during changing the compression ratio, the larger the proportion of injection through the in-passage injection valve 403 can be made. Likewise, the smaller the difference RI(#i) between the ignition delay correlative value DI(#i) and the target ignition delay correlative value DI_TR is during changing the compression ratio, the smaller the proportion of injection through the in-passage injection valve 403 can be made. Thus, during changing the compression ratios of all the cylinders 2, the proportion of injection through the in-passage injection valve 403 to the total quantity of fuel injected through the in-cylinder injection valve 3 and the in-passage injection valve 403 is made larger in the cylinder(s) 2 in which the air-fuel ratio is high than in the cylinder(s) 2 in which the air-fuel ratio is low.

As described above, in this embodiment, the proportion of injection through the in-cylinder injection valve 3 and the in-passage injection valve 403 in each cylinder 2 can be adjusted using the ignition delay correlative value DI(#i) of that cylinder 2. Thereby, differences in the air-fuel ratio among the cylinders 2 resulting from differences in the compression ratio changing speed among the cylinders 2 can be reduced.

In this embodiment, the time PMAX at which the in-cylinder pressure becomes highest is used in determining the ignition delay correlative value DI(#i). Alternatively, other points of time may be used instead. Such a point of time may be determined by experiment or simulation as a time that correlating with the ignition delay. While in this embodiment, the ignition delay correlative value is used as a physical quantity correlating with the air-fuel ratio, other physical quantities may be used instead. While the variable compression ratio changer having the structure shown in FIGS. 2 to 5 has been described in this embodiment, the present disclosure can be applied also to variable compression ratio changers having other structures that can change the compression ratio of the cylinders individually.

1. A control system for an internal combustion engine that controls an internal combustion engine include a plurality of cylinders, a variable compression ratio changer configured to change the compression ratio of each of the cylinders of the internal combustion engine individually, in-cylinder injection valves that inject fuel into the respective cylinders, and in-passage injection valves each of which injects fuel into an intake passage corresponding to each of the cylinders, comprising:
a controller configured to make the proportion of the quantity of fuel injected through said in-passage injection valves to the total quantity of fuel injected through said in-cylinder injection valves and said in-passage injection valves larger during the time in which the compression ratios of all the cylinders are being changed by said variable compression ratio changer than during the time in which the compression ratios of all the cylinders are fixed.

2. A control system for an internal combustion engine according to claim 1, wherein during the time in which the compression ratios of all the cylinders are being changed by said variable compression ratio changer, said controller farther configured to cause fuel to be injected only through said in-passage injection valves.

3. A control system for an internal combustion engine that controls an internal combustion engine include a plurality of cylinders, a variable compression ratio changer configured to change the compression ratio of each of the cylinders of the internal combustion engine individually, in-cylinder injection valves that inject fuel into the respective cylinders, and in-passage injection valves each of which injects fuel into an intake passage corresponding to each of the cylinders, comprising:
a controller configured to make the proportion of the quantity of fuel injected through said in-passage injection valve to the total quantity of fuel injected through said in-cylinder injection valve and said in-passage injection valve larger in a cylinder in which the air-fuel ratio is high than in a cylinder in which the air-fuel ratio is low, during the time in which the compression ratios of all the cylinders are being changed by said variable compression ratio changer.
